(19) United States
(12) Patent Application Publication
(10) Pub. No.: US 2025/0202976 A1
(43) Pub. Date: Jun. 19, 2025

(54) SYSTEM AND METHOD FOR DYNAMIC STATE SHARDING IN A DISTRIBUTED LEDGER

(71) Applicant: Omar Syed, Murphy, TX (US)

(72) Inventor: Omar Syed, Murphy, TX (US)

(21) Appl. No.: 18/545,572

(22) Filed: Dec. 19, 2023

(51) Int. Cl. H04L 67/1074; H04L 67/104; H04L 67/1097

(52) U.S. Cl. CPC H04L 67/108; H04L 67/1046; H04L 67/1097

(57) ABSTRACT

A system and method for dynamic state sharding in a distributed ledger are introduced. This approach involves organizing interconnected nodes within a network to efficiently manage data by dividing the address space into equal partitions and forming a ring-based structure. Nodes are assigned to store and manage data in primary partitions and additional adjacent partitions, enabling their participation in consensus for various accounts across these partitions. The system provides consensus when nodes join or leave the network, maintaining consistent performance during changes within the partitions. This method enhances data storage and consensus processing, offering improved scalability and fault tolerance.

### TECHNICAL FIELD

The present invention generally relates to a network of peer-to-peer computers storing local data to form a distributed ledger. More specifically, the present invention relates to a system and method for dynamic state sharding in a distributed ledger.

### BACKGROUND

In a typical sharded distributed ledger, state data is divided into smaller partitions called “shards” and sets of nodes, also referred to as computers or computing nodes or active nodes, are assigned to each shard. This helps the network to handle more transactions at the same time and increases parallel processing. However, in existing systems, the addition of new nodes doesn't immediately increase network throughput. Generally, a certain number of nodes need to be added to create a new shard, which will increase the network throughput. During the addition or removal of a shard, significant compute and bandwidth resources are required to reorganize the data among the nodes. This process is time-consuming and leads to the network being unavailable while the data is reorganized.

In traditional sharded distributed ledgers, static state sharding divides the address space into partitions. Each partition is managed and stored by subsets of nodes to enhance parallel processing. However, with static state sharding, the shard boundaries are fixed, so adding more shards or merging shards is difficult. A new shard cannot be created until the number of available new nodes is at least the number of nodes required per shard, S. Creating another shard will change the shard boundaries and require the nodes to change the data they store. As nodes try to change the data they store, there will be a spike in the network traffic between nodes and the normal processing of transactions will be disrupted. Similarly, when shards are merged, nodes will again have to change the data they store based on the new shard boundaries and the normal processing of transactions will be disrupted. Also, the network is not able to make use of extra nodes until the number of additional nodes is at least the number of nodes per shard.

A number of existing patent applications have attempted to tackle the issues outlined in the background section, serving as prior art related to the currently disclosed subject matter. These applications are discussed below:

US20190182313 assigned to Hyun Kyung Yoo and titled “Apparatus and method for processing blockchain transactions in a distributed manner” unveils a method employing sharding for processing blockchain transactions. Sharding involves multiple nodes with an identical shard and committees. This shard includes a Proof of Work block (PoW block), serving as data to verify nodes and process a hash value. The committee, including a sequence number, achieves consensus to store data sequentially. Once formed, the committee initiates the transaction process.

U.S. Pat. No. 9,411,862 assigned to Jue Wang and titled “Systems and methods for dynamic sharding of hierarchical data” introduces a system for assigning hierarchical data to multiple data shards. This system incorporates a hierarchical structure of a database and a computer system with a content server. The content server receives requests from resources, selects eligible items, and interacts with a dynamic sharding system. This dynamic sharding system uses entity count records to determine how the database should split based on the hierarchy level. It further splits the shards and assigns them to processing sites.

However, these existing references fall short in providing a system and method that enhance network scalability and throughput without the necessity of adding a specific number of new nodes to create additional shards. Additionally, they do not offer a system and method that minimizes network traffic during shard additions or removals, ensuring minimal disruption to normal transaction processing.

Consequently, there is a recognized need for a system and method for dynamic state sharding in a distributed ledger, specifically addressing one or more of the aforementioned drawbacks.

### SUMMARY

The present invention discloses a system and method for dynamic state sharding in a distributed ledger. The method involves organizing interconnected nodes within a network to efficiently manage data. The method is executed in a system comprising a plurality of nodes interconnected within a network. Each node comprises a memory storing one or more program modules. Each node is configured to execute the program modules to perform one or more operations.

The method involves dividing the address space into N partitions where N is the number of active nodes in the network. The last partition may have a different size than other partitions in most cases. The address space is treated as a ring such that the last address is adjacent to the first address. The N nodes are ordered by the node ID and each node is consecutively assigned to one partition. Each node is responsible for holding the data in the partition it is assigned to as well as the data in R+E partitions on either side. R is used to control how many partitions a node provides consensus on and is referred to as the shard radius. A node can participate in consensus for accounts stored in 2*R+1 partitions. E is used to control how many extra partitions beyond the shard radius a node stores. This allows nodes to continue providing consensus without waiting to acquire data even as some nodes join or leave the network and the partitions a node provides consensus on changes. The redundancy factor (or shard size) would be 2*R+1. Even though addresses are 256 bits, only the most significant 32 bits are used as unsigned integers for calculating partition boundaries.

For any given address the partition the address falls in can easily be determined. Since nodes are ordered based on node ID, the index of the partition the address falls in will also be the index of the primary node where the data for the given address can be found. In addition, the R nodes on both sides of the primary node will also be storing the data for the given address. This set of 2*R+1 nodes form the dynamic shard for the given address. Thus, for any given address, the nodes that hold the data for that address can be determined and form the dynamic shard for that address.

The above summary contains simplifications, generalizations and omissions of detail and is not intended as a comprehensive description of the claimed subject matter but, rather, is intended to provide a brief overview of some of the functionality associated therewith. Other systems, methods, functionality, features and advantages of the claimed subject matter will be or will become apparent to one with skill in the art upon examination of the following figures and detailed written description.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1 illustrates the network of nodes. The cloud at the center represents the Internet and each circle is a node.

FIG. 2 illustrates the details of a node. It contains a program module, a disk for storage and a connection to the Internet.

FIG. 3 illustrates the address space as a ring structure. The address space is divided into partitions and each node is assigned to a partition. Also shows the range of addresses covered by a node where R=2 and E=1.

FIG. 4 illustrates an example of static sharding with twelve nodes available in a conventional distributed ledger system. Each address is covered by three nodes with the overall address space being divided into four partitions.

FIG. 5 illustrates an example of static sharding with fourteen nodes available in a conventional distributed ledger system. Each address is covered by three nodes with the overall address space being divided into four partitions.

FIG. 6 illustrates a tabular representation of dynamic state sharding with twelve nodes available in a distributed ledger system. The overall address space is divided into twelve partitions, also called addresses ranges, with three nodes storing and consensing on data in each address range and also with three different nodes storing and consensing on data in three different address ranges. FIG. 6 highlights the division of the address space each node is responsible for, as indicated by the filled segments within the table. It also highlights how each node shares overlapping address space responsibilities ensuring redundancy and fault tolerance.

FIG. 7 depicts a tabular representation of dynamic state sharding with fourteen nodes available in a distributed ledger system. The overall address space is divided into fourteen partitions, also called addresses ranges, with three nodes storing and consensing on data in each address range and also with three different nodes storing and consensing on data in three different address ranges. FIG. 7 highlights the division of the address space each node is responsible for, as indicated by the filled segments within the table. It also highlights how each node shares overlapping address space responsibilities ensuring redundancy and fault tolerance and shows how new nodes can be immediately added to the network and create new shards.

FIG. 8 outlines a flowchart for a method of dynamic state sharding in a distributed ledger, detailing the steps from dividing the address space into partitions to enabling nodes to participate in consensus for accounts stored in primary and additional partitions.

### DETAILED DESCRIPTION OF EXAMPLE EMBODIMENTS

A description of embodiments of the present invention will now be given with reference to the Figures. It is expected that the present invention may be embodied in other specific forms without departing from its spirit or essential characteristics. The described embodiments are to be considered in all respects only as illustrative and not restrictive.

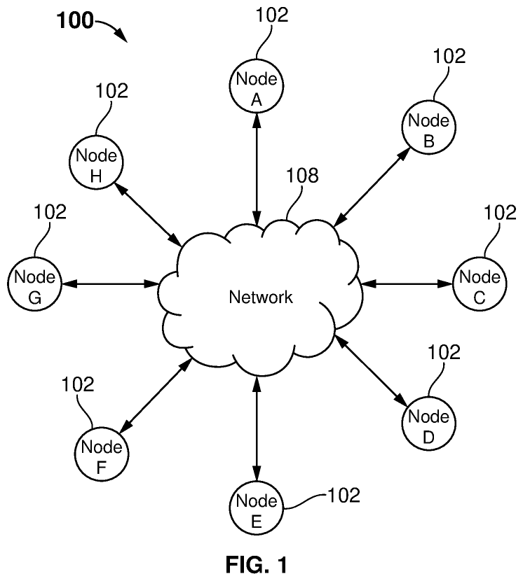

FIG. 1 illustrates an environment 100 of a system for dynamic state sharding in a distributed ledger, according to an embodiment of the present invention. The system is configured to enable each computing node 102 within a network to cover a distinct address range while ensuring that each address is covered by the required number of nodes 102.

The environment 100 comprises one or more computing nodes A, B, C, D, E, F, G, H 102 interconnected via a network 108. The computing nodes A, B, C, D, E, F, G, H 102 are generally also referred to as a computing node 102 or a node 102. The node 102 is also referred to as computer/computers and active nodes. The distributed ledger system comprises a plurality of computing nodes 102. The plurality of computing nodes 102 are connected to one another via a network. The network 108 generally represents one or more interconnected networks, over which the resources and the computing node 102 could communicate with each other. The network 108 may include packet-based wide area networks (such as the Internet), local area networks (LAN), private networks, wireless networks, satellite networks, cellular networks, paging networks, and the like. A person skilled in the art will recognize that the network 108 may also be a combination of more than one type of network. For example, the network 108 may be a combination of a LAN and the Internet. In addition, the network 108 may be implemented as a wired network, or a wireless network or a combination thereof.

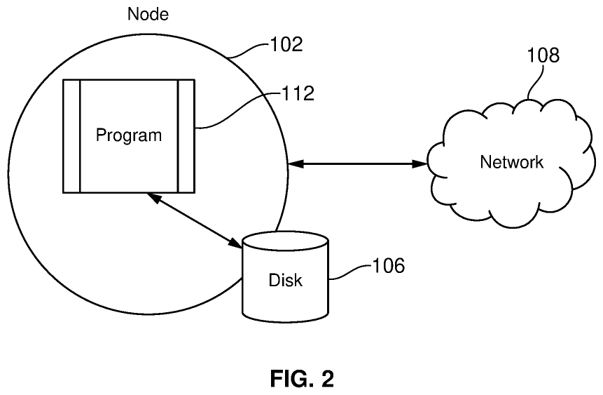

Referring to FIG. 2, the computing node 102 contains a disk and a program module. Although not explicitly shown, a node is expected to contain memory to store the program module and a CPU to execute the program module. The node 102 also includes a connection to a network through which it can communicate with other nodes. The computing node 102 is part of a distributed ledger system.

Referring to FIG. 2, the computing node 102 or server is at least one of a general or special purpose computer. In an embodiment, it operates as a single computer, which can be a hardware, a workstation, a desktop, a laptop, a tablet, a mobile phone, a mainframe, a supercomputer, a server farm, and so forth. In an embodiment, the computer could run on any type of OS, such as iOS™, Windows™, Android™, Unix™, Linux™, and/or others. In an embodiment, the computing node 102 is in communication with network 108 and the distributed ledger system.

Referring to FIG. 2, the database 106 is accessible by the computing node 102. In an example, the database 106 resides in the computing node 102. In another example, the database 106 resides separately from the computing node 102. Regardless of location, the database 106 comprises a memory to store and organize data for use by the computing node 102.

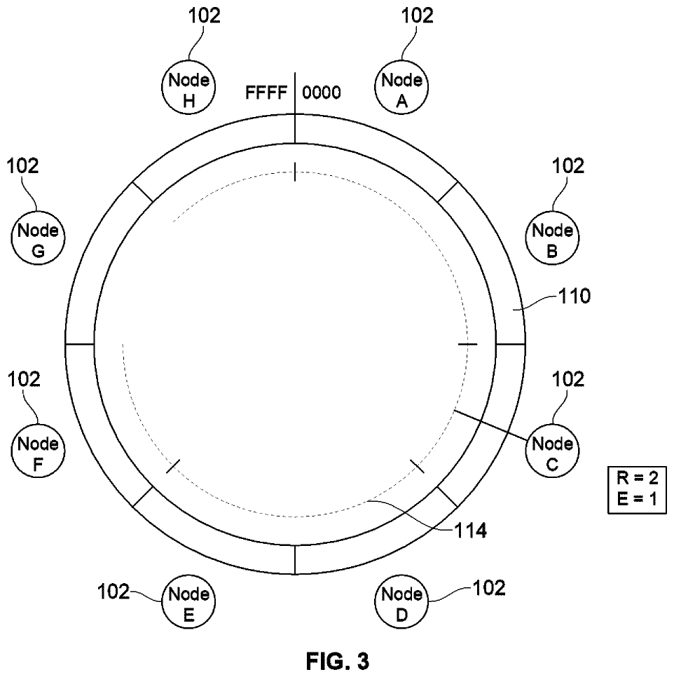

Referring to FIG. 3, the distributed ledger system is configured to divide an address space into a number of partitions 110 and form a ring-based structure. The number of active nodes 102 in the network is represented as N. Active nodes are the individual computing units (nodes) within a distributed ledger network that are actively participating in the network's operations at any given time. These nodes are responsible for storing and processing data, specifically handling different address ranges within the network. The number of partitions 110 equals the number of active nodes 102 in the network. The ring structure provides an arrangement of address space in which a last address is adjacent to a first address. The line 114 shows the perimeter covered by the nodes 102.

Referring to FIG. 3, the N nodes 102 are ordered by the node ID and each node 102 is consecutively assigned to one primary partition 110. Additionally, each node 102 is assigned to store and manage data within a primary partition 110, as well as the adjacent partitions 110 on both sides of the primary partition 110. The additional partitions 110 are determined using R+E, where R represents the shard radius and E controls the extent of a node's responsibility for storing data in the network.

Referring to FIG. 3, the distributed ledger system is configured to determine the number of partitions 110 to enable each node 102 to provide consensus within the network using 2*R+1. R is a shard radius that controls the number of partitions 110 for which the node is enabled to provide consensus. The distributed ledger system is configured to enable nodes 102 to participate in consensus for accounts stored in the 2*R+1 partitions.

Referring to FIG. 3, the distributed ledger system is configured to enable nodes 102 to provide continuous consensus even as nodes join or leave the network without interruptions. Furthermore, the distributed ledger system is configured to enable the nodes 102 to provide continuous consensus, even as the size of the partitions 110 change with the addition or removal of nodes. The redundancy factor (or shard size) would be 2*R+1. Even though addresses are 256 bits, only the most significant 32 bits are used as unsigned integers for calculating partition boundaries.

Referring to FIG. 3, in the distributed ledger system, each node 102 has a node ID. The order of nodes 102 is organized by node IDs and aligns with the indexing of partitions. Consequently, for any given address, the index of the partition containing the address corresponds to the index of the primary node 102 responsible for storing data associated with that address. Furthermore, encompassing the primary node 102, there exist R nodes 102 on either side that also store the data related to the given address. This set of 2*R+1 nodes collectively constitute the dynamic shard allocated for the specified address. Thus, the set of nodes in the dynamic shard for any given address can easily be determined by determining the nodes 102 storing data pertinent to that address.

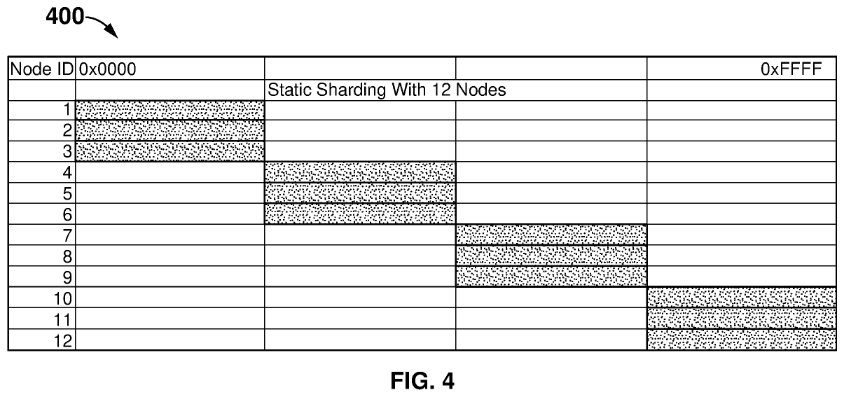

FIG. 4 displays a table designated by numeral 400, which visualizes the allocation of address space in a distributed ledger using static state sharding. The table is headed by ‘Node ID’ at the left, followed by a range indicating the starting point ‘0x0000’ and ending point ‘0xFFFF’ for the hexadecimal address space. The twelve rows correspond to twelve individual nodes, each row beginning with a unique node identifier (1 through 12).

Within the table, the shaded areas across the rows represent the partitions of the address space, also called address ranges, for which each node (1 to 12) is responsible, showing no overlap between the nodes' address ranges.

Excluding the ‘Node ID’ column, the other four columns display that the overall address space is divided into four partitions, with three nodes storing and consensing on data in each address range.

This static assignment indicates that each node is exclusively responsible for storing and consensing on data for its designated address range, from the starting hexadecimal address ‘0x0000’ to the ending ‘0xFFFF’, without any redundancy or overlap with other nodes' address ranges. The figure serves to contrast the rigidity of static sharding against the flexibility of dynamic state sharding in a distributed ledger system.

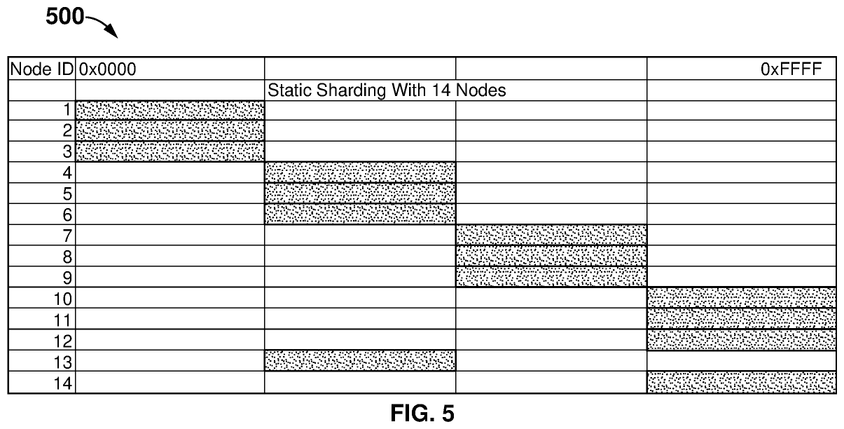

FIG. 5 displays a table designated by numeral 500, which visualizes the allocation of address space in a distributed ledger using static state sharding. The table is headed by ‘Node ID’ at the left, followed by a range indicating the starting point ‘0x0000’ and ending point ‘0xFFFF’ for the hexadecimal address space. The fourteen rows correspond to fourteen individual nodes, each row beginning with a unique node identifier (1 through 14).

Within the table, the shaded areas across the rows represent the partitions of the address space, also called address ranges, for which each node (1 to 14) is responsible, showing no overlap between the nodes' address ranges.

Excluding the ‘Node ID’ column, the other four columns display that the overall address space is divided into four partitions, with three nodes storing and consensing on data in each address range.

This static assignment indicates that each node is exclusively responsible for storing and consensing on data for its designated address range, from the starting hexadecimal address ‘0x0000’ to the ending ‘0xFFFF’, without any redundancy or overlap with other nodes' address ranges. The figure shows that in a distributed ledger system using static state sharding, nodes must be assigned to pre-existing address ranges and are not able to form a new shard until additional nodes become available.

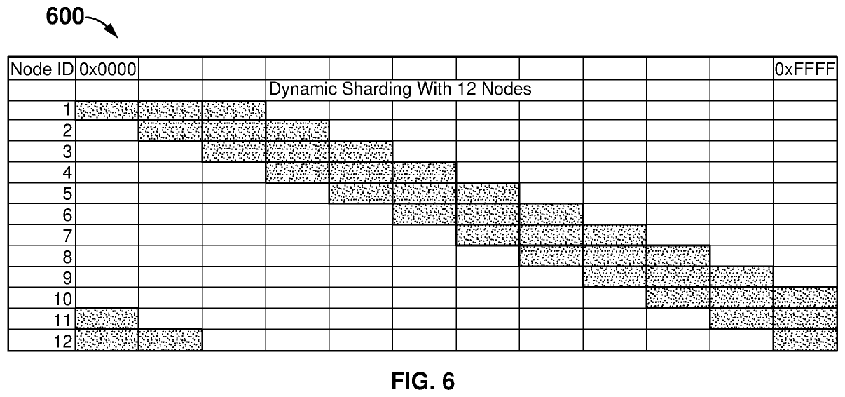

FIG. 6 displays a table designated by numeral 600, which visualizes the allocation of address space in a distributed ledger using dynamic state sharding. The table is headed by ‘Node ID’ at the left, followed by a range indicating the starting point ‘0x0000’ and ending point ‘0xFFFF’ for the hexadecimal address space. The twelve rows correspond to twelve individual nodes, each row beginning with a unique node identifier (1 through 12).

Within the table, the shaded areas across the rows represent the partitions of the address space, also called address ranges, for which each node (1 to 12) is responsible. Unlike static state sharding, these patterns overlap across adjacent rows, indicating that multiple nodes dynamically share responsibility for overlapping address ranges.

Excluding the ‘Node ID’ column, the other twelve columns display that the overall address space is divided into twelve partitions, with three nodes storing and consensing on data in each address range. Each node also is storing and consensing on data in address ranges that are adjacent on both sides to the primary partition that the node has been assigned to.

This assignment indicates that each node is exclusively responsible for storing and consensing on data for its designated address range, from the starting hexadecimal address ‘0x0000’ to the ending ‘0xFFFF’, whilst achieving redundancy and overlap with other nodes' address ranges. The figure shows that in a distributed ledger system using dynamic state sharding, the number of partitions is equal to the number of active nodes in the network, thereby enabling redundancy and fault tolerance.

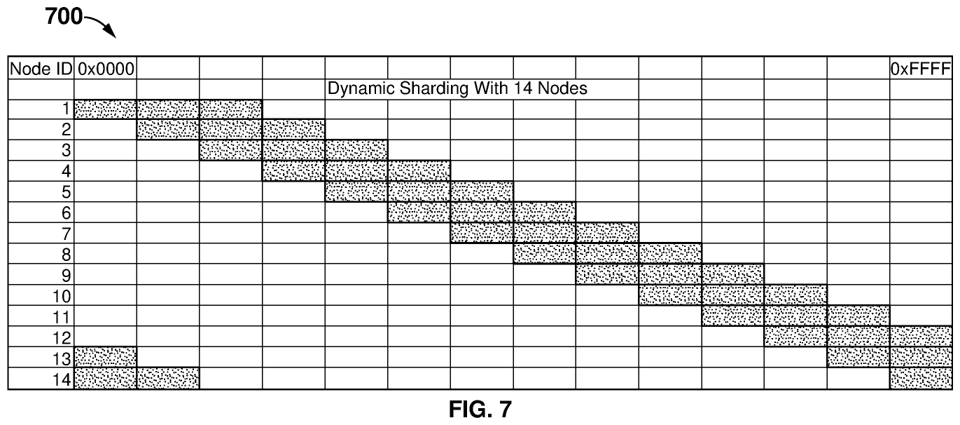

FIG. 7 displays a table designated by numeral 700, which visualizes the allocation of address space in a distributed ledger using dynamic state sharding. The table is headed by ‘Node ID’ at the left, followed by a range indicating the starting point ‘0x0000’ and ending point ‘0xFFFF’ for the hexadecimal address space. The fourteen rows correspond to fourteen individual nodes, each row beginning with a unique node identifier (1 through 14).

Within the table, the shaded areas across the rows represent the partitions of the address space, also called address ranges, for which each node (1 to 14) is responsible. Unlike static state sharding, these patterns overlap across adjacent rows, indicating that multiple nodes dynamically share responsibility for overlapping address ranges.

Excluding the ‘Node ID’ column, the other fourteen columns display that the overall address space is divided into fourteen partitions, with three nodes storing and consensing on data in each address range. Each node is also storing and consensing on data in address ranges that are adjacent on both sides to the primary partition that the node has been assigned to.

This assignment indicates that each node is exclusively responsible for storing and consensing on data for its designated address range, from the starting hexadecimal address ‘0x0000’ to the ending ‘0xFFFF’, whilst achieving redundancy and overlap with other nodes' address ranges. The figure shows that in a distributed ledger system using dynamic state sharding, the number of partitions is equal to the number of active nodes in the network, thereby enabling redundancy and fault tolerance. It also highlights that additional nodes can be added instantly to dynamically form new shards.

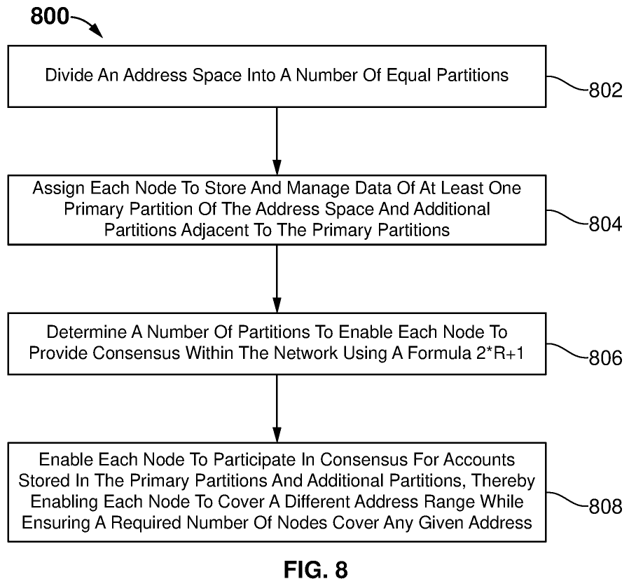

FIG. 8, shows a flowchart 800 of a method for dynamic state sharding in a distributed ledger, according to an embodiment of the present invention. The method is executed in a system comprising a distributed ledger system. The distributed ledger system comprises a plurality of nodes 102 interconnected within a network. Each node 102 comprises a memory storing one or more program modules. The nodes 102 are configured to execute the program modules to perform operations. Each node 102 comprises one or more shards storing a subset of a complete data.

The flowchart begins at step 802, the system is programmed to divide the address space into N equal sized partitions where N is the number of active nodes in the network. The last address is considered to be adjacent to the first address such that the address space forms a ring structure.

At step 804, the system is programmed to assign each node 102 to store and manage data of at least one primary partition of the address space and additional partitions adjacent to the respective primary partitions. The additional partitions are determined using R+E, where R represents the shard radius and E controls the extent of a node's responsibility for storing data in the network.

At step 806, the system is configured to determine a number of partitions to enable each node 102 to provide consensus within the network using the formula 2*R+1. R is the shard radius and controls a number of the partitions the node 102 is enabled to provide consensus.

At step 808, the system is configured to enable each node 102 to participate in consensus for accounts stored in the respective primary partitions and additional partitions, thereby enabling each node 102 to cover a different address range while ensuring a required number of nodes 102 cover any given address. The system enables the nodes 102 to provide continuous consensus even as nodes 102 join the network, leave the network or the partition for which the node 102 provides consensus undergoes changes.

The present invention allows each node 102 to cover a different address range while ensuring a required number of nodes 102 cover any given address. This enhances the network's scalability and efficiency by immediately incorporating new nodes 102 to process more transactions. The invention enables linear scaling as nodes 102 are added to the network, directly increasing the network's capacity and throughput. It overcomes the stepwise scaling limitations of traditional static state sharding, where adding new nodes 102 doesn't immediately improve network performance. The redundancy factor, defined as 2*R+1, ensures that data at any given address is stored by at least S nodes. This redundancy enhances data reliability and fault tolerance, contributing to a robust and resilient network. The invention divides the address space into equal partitions 110 based on the number of active nodes 102 (N) in the network. Each node 102 is assigned a partition 110 and is responsible for holding data within its partition 110 and a defined radius (R) of partitions 110 on either side.

The system further provides efficient data management and consensus. Nodes 102 participate in consensus for accounts stored in 2*R+1 partitions 110, allowing for efficient data management without significant disruption during shard additions, removals, or reorganizations. The system efficiently determines the partition 110 and primary node 102 for a given address, facilitating quick access to data. The nodes 102 around the primary node 102 form the dynamic shard for the given address, ensuring redundancy and availability.

Furthermore, by reducing the address range covered by each node 102 with the addition of new nodes 102, the network's parallel processing capabilities are enhanced, leading to improved performance and reduced processing times for transactions.

According to the present invention, the address ranges overlap to ensure redundancy, where each node 102 holds data for a different address range, increasing fault tolerance and reliability in case of node 102 failures.

The invention minimizes network traffic during shard additions or removals, ensuring that normal transaction processing is minimally disrupted. It reduces the amount of data that needs to be transferred when shard boundaries change, making the network more efficient. The system enables rapid and efficient shard creation. Unlike static sharding, the invention enables the immediate use of additional nodes 102 without waiting to accumulate a specific number of nodes 102 for shard creation, enhancing the network's responsiveness and throughput. These features collectively contribute to a more efficient, scalable, and dynamic distributed ledger system through the innovative approach of dynamic state sharding.

In addition to the aforementioned key features, the implementation of dynamic state sharding on a distributed ledger offers a significant advantage in terms of reducing transaction fees. This advantage stems from the fact that less nodes are involved in processing a transaction in a sharded network than in an unsharded network. Thus, less nodes need to be paid which translates to lower transaction fees for the users.

With dynamic state sharding, each node 102 covers a specific address range and is responsible for processing transactions related to that range. This means that not every node 102 in the network is burdened with verifying and validating every transaction, leading to less transaction processing for each node 102.

During the processing of a transaction, only a subset of nodes 102 that are part of the relevant shards (determined by the addresses involved in the transaction) are actively involved in processing and validating the particular transaction. The rest of the nodes 102 are not engaged in processing this transaction, reducing the overall transaction load on the network. As a result of a smaller subset of nodes 102 processing each transaction, less transaction fees are needed to pay the nodes. Less nodes involved in processing the transaction implies less computational and energy resources are required per transaction, leading to lower transaction fees for users.

Furthermore, dynamic state sharding optimizes resource utilization by directing transaction processing to the subset of nodes 102 relevant to each transaction. This efficient allocation of resources helps in cost reduction and, consequently, in lowering transaction fees for users of the distributed ledger application. By effectively implementing dynamic state sharding and allowing only a subset of nodes 102 to process specific transactions, the invention enhances the efficiency and scalability of the network, leading to reduced transaction fees and a more cost-effective user experience.

What is claimed is:

1. A computer-implemented method for dynamic state sharding in a distributed ledger, comprising the steps of:
dividing an address space on a computer memory device into a number of equal partitions, where the number of partitions is equal to the number of active nodes in a computer network;
wrapping the address space such that the last address is adjacent to the first address to form a ring structure;
assigning consecutively each computer terminal node to store and manage data of at least one primary partition and additional partitions adjacent to the primary partition;
enabling each computer terminal node to participate in consensus for accounts stored in respective primary partitions and additional partitions;
enabling each computer terminal node to store a different address range;
and comparing the number of computer terminal nodes storing a given address to a predetermined required number.

2. The method of claim 1, further comprises a step of: determining the number of partitions to enable each node to provide consensus within the network, calculated using 2*R+1, where R is the shard radius that manages the number of partitions for which the node is enabled to provide consensus and redundancy.

3. The method of claim 1, wherein the node is enabled to maintain continuous consensus, allowing for the accommodation of nodes joining or leaving the network.

4. The method of claim 1, wherein the node is enabled to maintain continuous consensus when there are changes to the size of the partitions stored by the node.

5. The method of claim 1, wherein at least one partition has a different size than the other equally sized partitions.

6. The method of claim 1, wherein the partition of any given address is determined by an index of the partition.

7. The method of claim 1, wherein the additional partitions are determined using R+E, wherein R represents the shard radius and E controls the extra partitions beyond R that a node should store.

8. The method of claim 1, wherein the nodes are arranged based on individual node ID.

9. The method of claim 1, further comprising the step of: employing the most significant 32 bits of the 256-bit addresses as unsigned integers to calculate partition boundaries and determine data distribution across nodes.

10. The method of claim 1, further comprising the step of: facilitating identification of a primary node storing data for the address based on the index of the partition, wherein each node is assigned a unique node ID that determines its position in the sequence.

11. The method of claim 1, further comprising the step of: ensuring storage of data for the given address by a primary node and nodes adjacent to both sides of the primary node, forming a dynamic shard comprising 2*R+1 nodes responsible for the address's data storage and consensus provision.

12. A system for dynamic state sharding in a distributed ledger, comprising:
a plurality of nodes interconnected within a network,
wherein each node includes a memory storing one or more program modules,
wherein each node is configured to execute the program modules to perform one or more operations,
wherein each node comprises one or more shards storing a subset of a complete data, and
wherein each node employs the method of claim 1.

13. The system of claim 12, encompasses overlapping shard boundaries, where individual nodes concurrently belong to multiple shards.
